(19) United States
(12) Patent Application Publication
(10) Pub. No.: US 2025/0092693 A1
(43) Pub. Date: Mar. 20, 2025

(54) LADDER SYSTEM WITH ATTACHED WALKWAY

(71) Applicant: Ballymore Company, Inc., Coatsville, PA (US)

(72) Inventor: William F Frame, Coatsville, PA (US)

(21) Appl. No.: 18/891,452

(22) Filed: Sep. 20, 2024

Related U.S. Application Data
(60) Provisional application No. 63/583,886, filed on Sep. 20, 2023.

(51) Int. Cl. E04G 5/10; E04G 1/24; E04G 5/14

(52) U.S. Cl. CPC E04G 5/10; E04G 1/24; E04G 5/14; E04G 2001/246

(57) ABSTRACT

A ladder system includes a first ladder, a second ladder, and an intermediate walkway spanning between the first and second ladders. The ladders may be rollable and the walkway may be detachable. The ladders may include a swingable gate between the side of the ladder and the walkway which permits access onto the walkway.

### CROSS REFERENCE TO RELATED APPLICATIONS

This application also claims the benefit of U.S. Provisional Application No. 63/583,886, filed Sep. 20, 2023. The entire disclosure of which is incorporated herein by reference.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

The Invention relates to a combination of rolling ladders and an attached intermediate walkway.

### SUMMARY

The invention is a ladder system which includes a first ladder, a second ladder, and an intermediate walkway spanning between the first and second ladders. The ladders may be rollable and the walkway is detachable.

The ladders may include a swingable gate between the side of the ladder and the walkway which permits access onto the walkway and the walkway may include front and rear handrails.

In one form of the invention, the walkway includes a pair of connected plank sections and a connection for attaching the walkway to a side of each ladder. The walkway may further include front and rear handrails and connections disposed on the front and rear faces of the walkway to receive the front and rear handrails therein. The walkway may include laterally extending C-shape hooks for attaching to a top step of each ladder on a horizontally extending bar mounted to each ladder and a brace extending from a stringer of the ladder for supporting the horizontally extending bar.

### BRIEF DESCRIPTION OF THE DRAWINGS

The embodiments will be described in detail with reference to the following drawings in which like reference numerals refer to like elements wherein:

FIG. 1 shows a front perspective view of rolling ladders with an attached intermediate walkway in accordance with the present invention.

FIG. 2 shows a shows a rear perspective view of the ladder system in accordance with the present invention shown in FIG. 1.

FIG. 3 shows a front elevational view of the ladder system in accordance with the present invention shown in FIG. 1.

FIG. 4 shows a rear elevational view of the ladder system in accordance with the present invention shown in FIG. 1.

FIG. 5 shows a right side elevational view of the ladder system in accordance with the present invention shown in FIG. 1.

FIG. 6 shows a left side elevational view of the ladder system in accordance with the present invention shown in FIG. 1.

FIG. 7 shows a top view of the ladder system in accordance with the present invention shown in FIG. 1.

FIG. 8 shows a bottom view of the ladder system in accordance with the present invention shown in FIG. 1.

FIG. 9 shows a front exploded perspective view of the ladder system in accordance with the present invention shown in FIG. 1.

FIG. 10 shows a partial enlarged front exploded perspective view of the ladder system in accordance with the present invention shown in FIG. 1.

FIG. 11 shows a front exploded perspective view of the walkway of the ladder system in accordance with the present invention shown in FIG. 1.

FIG. 12 shows a rear exploded perspective view of the walkway of the ladder system in accordance with the present invention shown in FIG. 1.

FIG. 13 shows another front exploded perspective view of the walkway of the ladder system in accordance with the present invention shown in FIG. 1.

FIG. 14 shows another rear exploded perspective view of the walkway of the ladder system in accordance with the present invention shown in FIG. 1.

FIG. 15 shows a partial exploded perspective view of the walkway of the ladder system in accordance with the present invention shown in FIG. 1.

### DETAILED DESCRIPTION

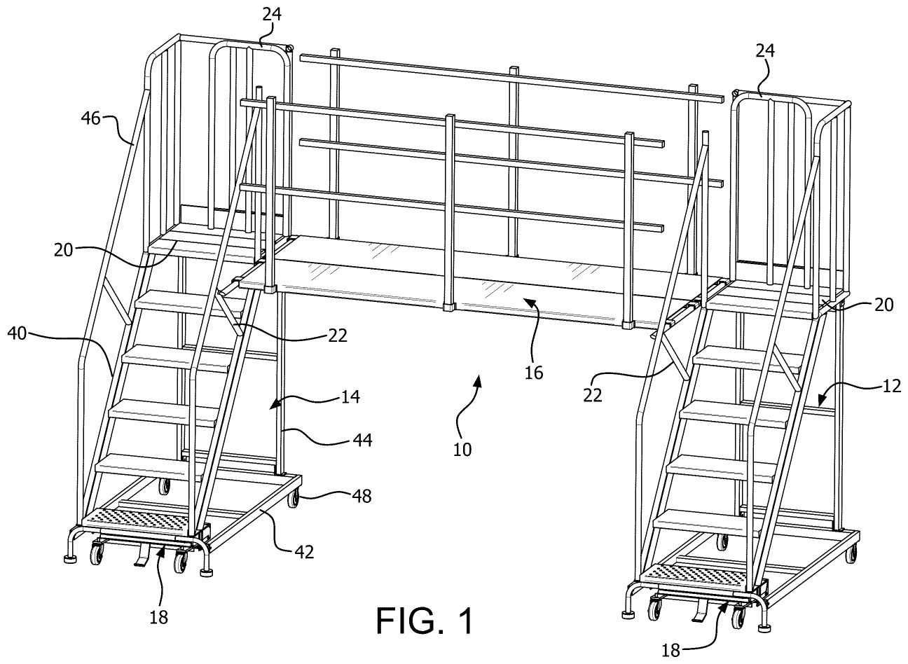

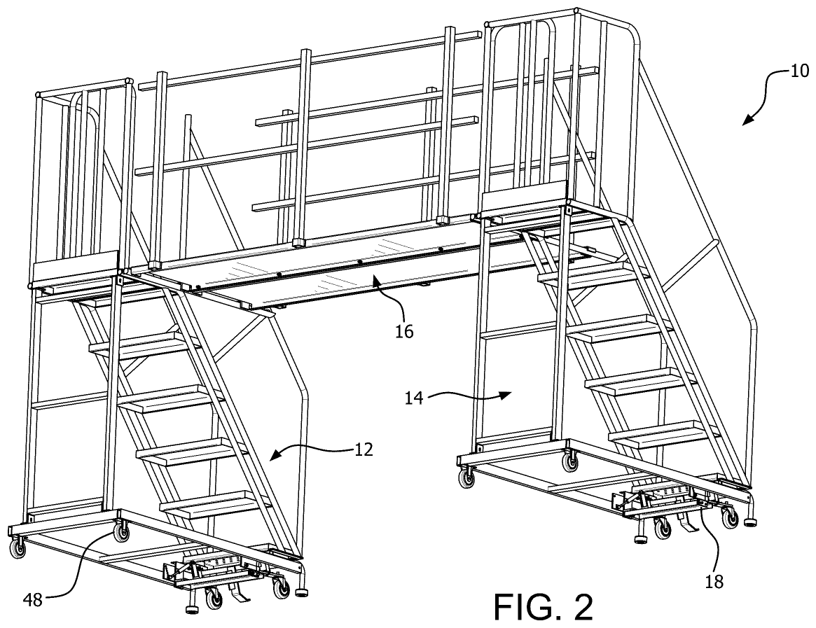

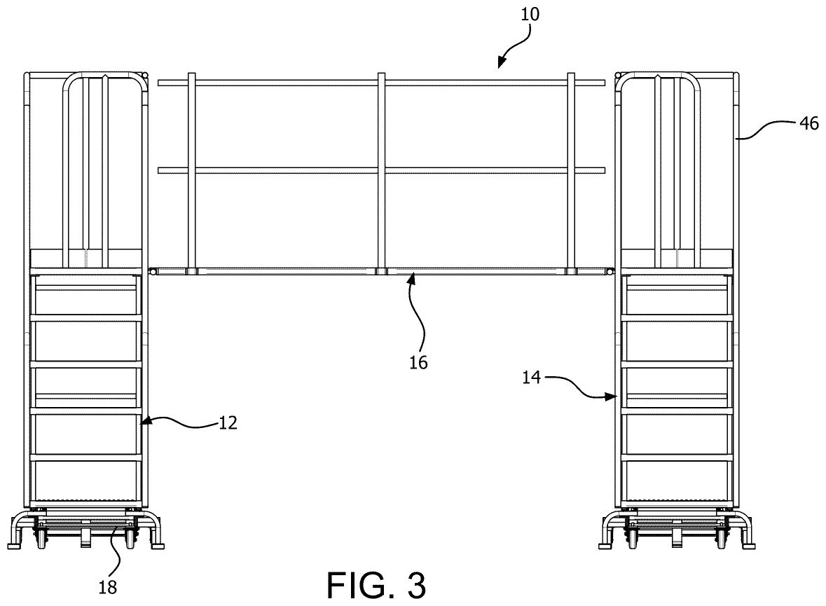

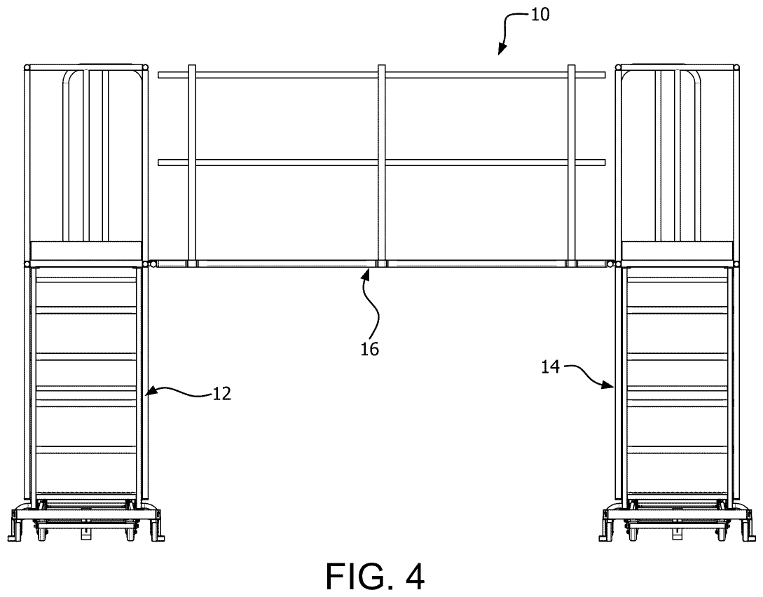

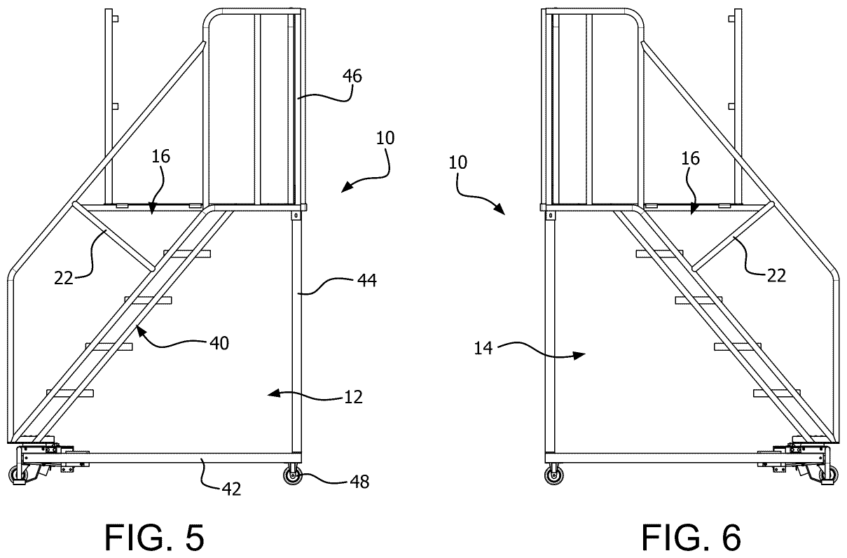

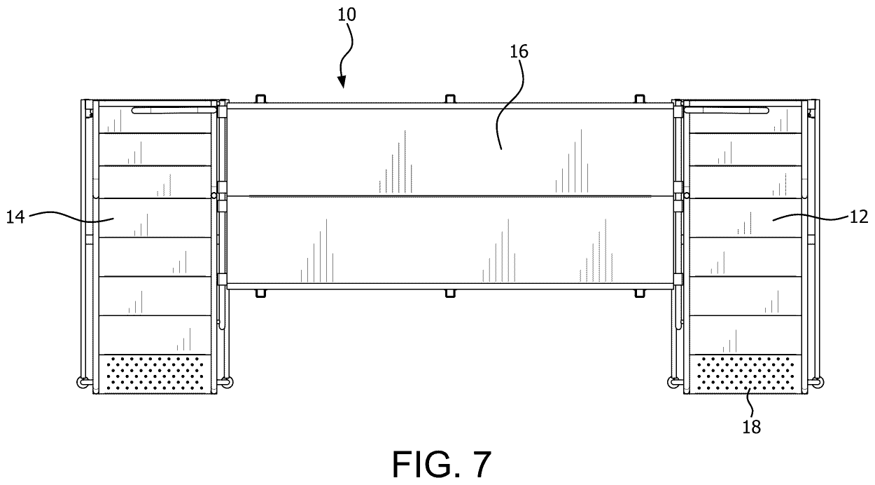

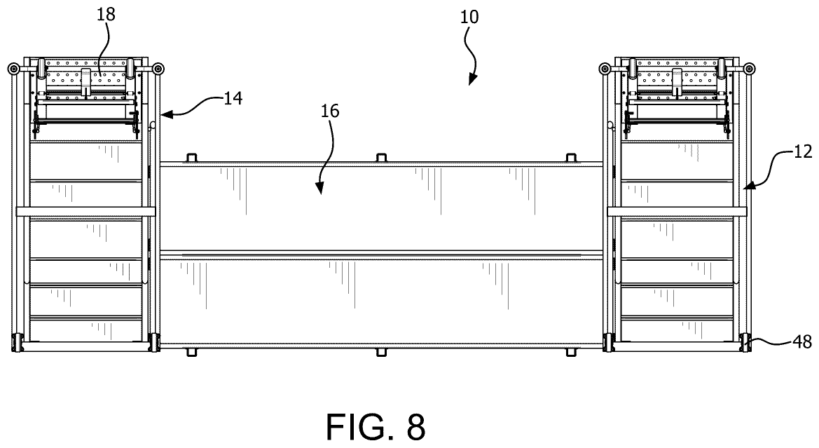

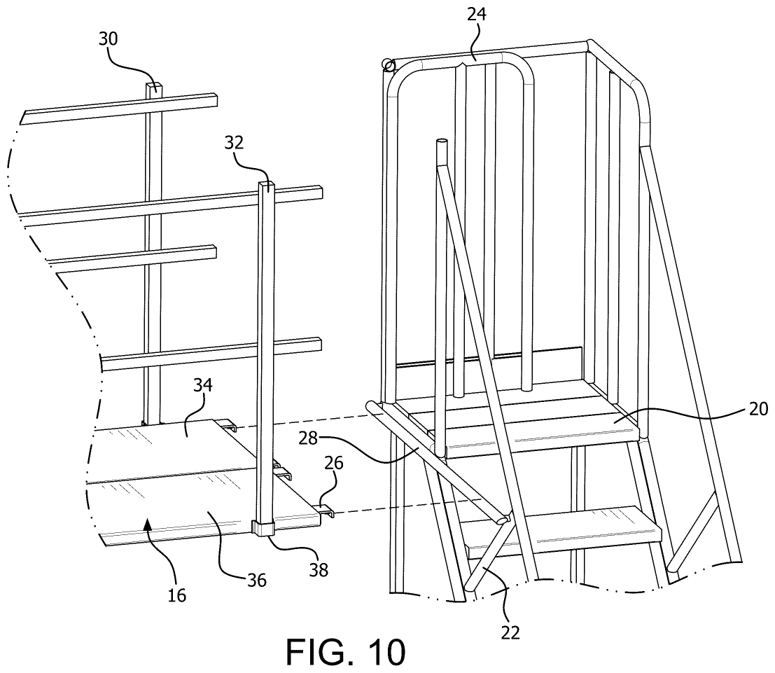

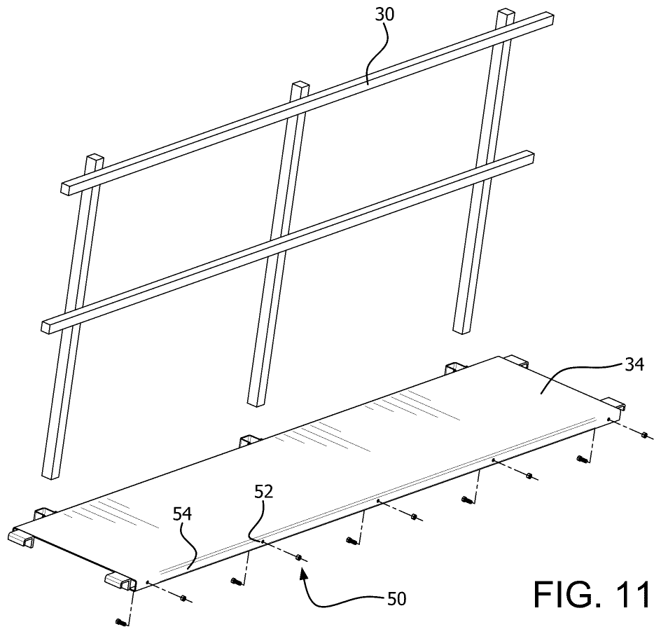

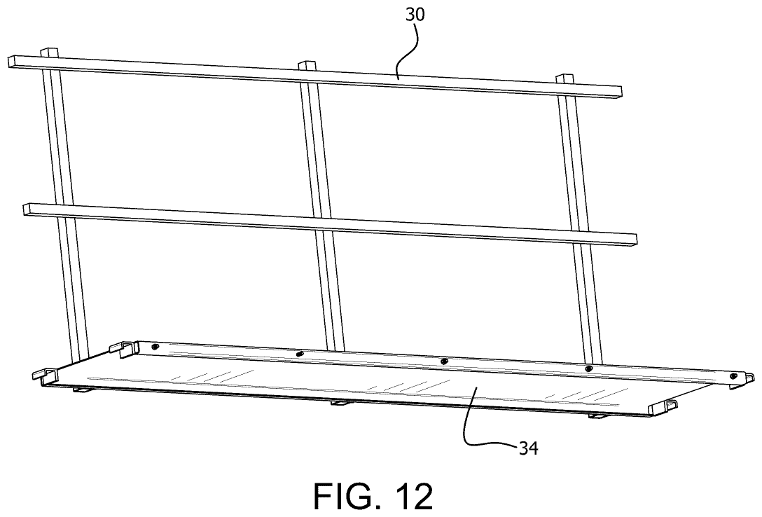

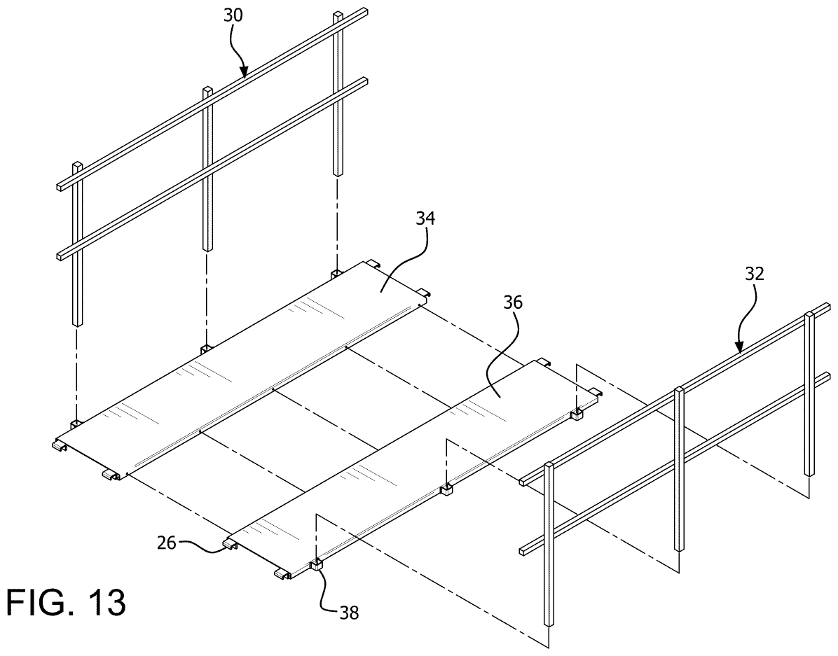

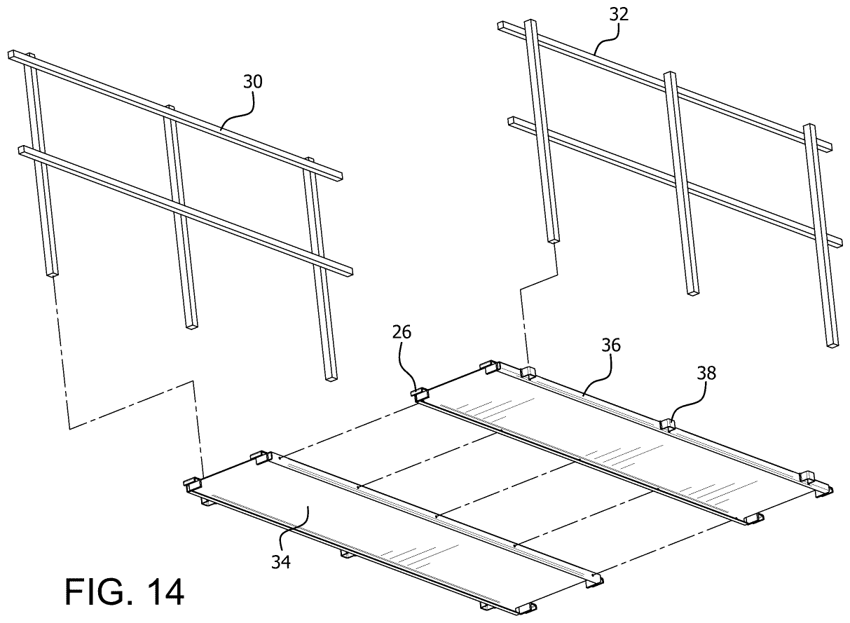

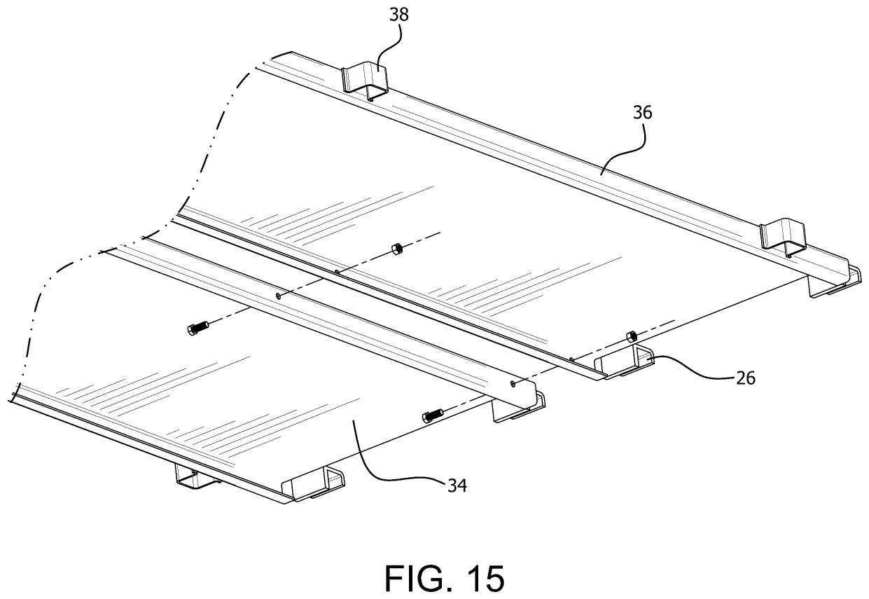

In FIGS. 1-15, there is shown a preferred embodiment of a combination of rolling ladders and an attached intermediate walkway 10 in accordance with the present invention.

The ladder system 10 includes a pair of rollable lightweight, maneuverable ladders 12 and 14, and contains proprietary lift assist lock step 18. The ladders 12 and 14 are fixedly assembled (preferably by the use of bolt connections such that no user adjustment needed for easy assembly).

A walkway 16 spans between the ladders 12 and 14 and is attached to both ladders at a top step 20 thereof. Braces 22 supports the front of the walkway 26 by resting on a stringer 40 of the ladder which supports the walkway 16.

The ladders may include a lift assist lock 18 which is secured to the at the base of each ladder 12 and 14, preferably by bolt connections. Other connections are contemplated and form part of the invention.

The ladders 12 and 14 and walkway 16 are attached together, preferably by bolt connectors with minimum fasteners and requires no adjustment to set up.

Each ladder 12 and 14 includes a base 42, a vertical support 44 extending vertically therefrom, a stringer portion 40 connecting between the base 42 and the top of the vertical support 44, and hand rails 46. Each ladder 12 and 14 also includes a locking swingable gate 24 disposed on an inward side location at the top step 20 of the ladders and connected to the handrail 46 that extends around the top step 20 of the ladders. The ladders 12 and 14 also comprises casters 48 to allow for rollability thereof.

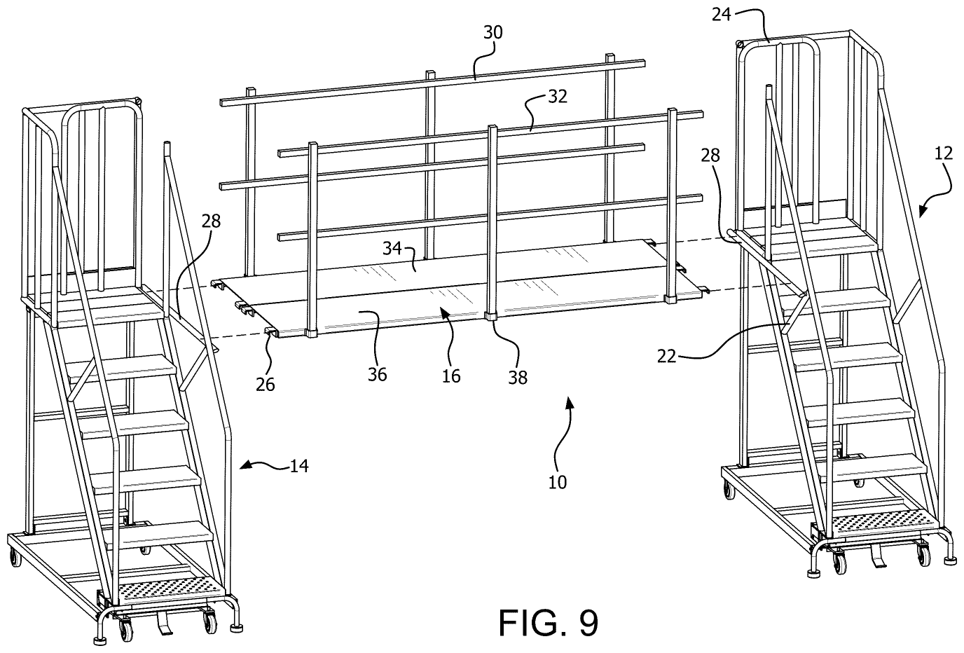

Turning now to FIGS. 9-15, the walkway 16 is shown in more detail. The walkway preferably comprises a first and second plank sections 34 and 36 that are attached together with suitable fasteners 50 which are accepted in fastener holes 52 which are spaced along a side wall 54 of each plank sections 34 and 36.

Connections 38 are provided along one edge of each of planks 34 and 36 to receive a section of handrail 30 and 32. On both lateral edges of each plank 34 and 36 C-shaped connections 26 extend from the lateral edge wall and are provided to attach to a horizontal extending member 28 that extends forwardly from the top step 20 of each ladder 12 and 14 and is fixedly attached to brace 22 which supports the cantilevered member 28 at one end by contacting a stringer rail of the respective ladder.

The ladders 12 and 14 preferably have 6 or 7 steps. The gates 24 provide a side exit for each ladder 12 and 14 onto the walkway 16. The walkway 16 is intended to span racking and inventory and provide about 40 inches of working space thereon. The walkway 16 is readily detachable if needed and the two ladders 12 and 14 may be used separately if desired. The detachable handrails 30 and 32 are intended to protect the user while on the walkway 16. The walkway is designed to bear a 500 pound load of more with a one or two person capacity.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A ladder system comprising:
a first ladder,
a second ladder, and
an intermediate walkway spanning between the first and second ladders.

2. The ladder system comprising according to claim 1 wherein the ladders are rollable and the walkway is detachable.

3. The ladder system comprising according to claim 1 wherein the ladders comprise a swingable gate between the side of the ladder and the walkway which permits access onto the walkway.

4. The ladder system comprising according to claim 1 wherein the walkway comprises front and rear handrails.

5. The ladder system comprising according to claim 1 wherein the walkway includes a pair of connected plank sections and a connection for attaching the walkway to a side of each ladder.

6. The ladder system comprising according to claim 5 wherein the walkway further comprises front and rear handrails and connections disposed on the front and rear faces of the walkway to receive the front and rear handrails therein.

7. The ladder system comprising according to claim 6 wherein the ladders comprise a swingable gate between the side of the ladder and the walkway which permits access onto the walkway.

8. The ladder system comprising according to claim 7 wherein the walkway comprises laterally extending C-shape hooks for attaching to a top step of each ladder on a horizontally extending bar mounted to each ladder.

9. The ladder system comprising according to claim 8 wherein each ladder includes a brace extending from a stringer of the ladder for supporting the horizontally extending bar.
